(19) United States
(12) Patent Application Publication
(10) Pub. No.: US 2026/0296412 A1
(43) Pub. Date: Oct. 1, 2026

(54) VEHICLE CONTROL APPARATUS AND PROGRAM PRODUCT

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Masahide KUWATA, Tokyo (JP); Yuji KOSAKA, Tokyo (JP); Takahiro NAKANO, Tokyo (JP)

(21) Appl. No.: 19/575,182

(22) Filed: Mar. 23, 2026

(30) Foreign Application Priority Data
Mar. 25, 2025 (JP) 2025-050651

(51) Int. Cl. B60W 30/09; G08G 1/16

(52) U.S. Cl. CPC B60W 30/09; G08G 1/167; B60W 2552/10; B60W 2554/4041; B60W 2554/4045; B60W 2554/802; B60W 2720/106; B60W 2754/30

(57) ABSTRACT

In a vehicle control apparatus, an acquiring unit acquires, from a detection device, detection information related to an external vehicle traveling in the adjacent lane having the same traffic direction as the host lane. A close-range determiner determines, upon the external vehicle cutting in front of the host vehicle, whether a cut-in state of the external vehicle is a close-range cut-in state in accordance with the detection information. The close-range cut-in state denotes a state in which an inter-vehicle distance between the host vehicle and the external vehicle is smaller than a close-range determination value. A deceleration controller controls, in response to determination that the cut-in state is the close-range cut-in state, deceleration of the host vehicle based on (i) the detection information and (ii) a continuation time during which the close-range determiner continuously determines that the cut-in state is the close-range cut-in state.

### CROSS-REFERENCE TO RELATED APPLICATION

This present application is based on and claims the benefit of priority from Japanese Patent Application 2025-050651 filed on Mar. 25, 2025, the disclosure of which is incorporated herein by reference.

### TECHNICAL FIELD

The present disclosure relates to a vehicle control apparatus and a program product.

### BACKGROUND

A known technology, which is applied to a vehicle control apparatus for driving assistance of a host vehicle, detects a vehicle cutting in front of the host vehicle from an adjacent lane and controls the acceleration/deceleration of the host vehicle in response to the cut-in of the cut-in vehicle. The known technology is, for example, disclosed in Japanese Patent Application Publication No. 2023-117727.

### SUMMARY

When a vehicle cutting in front of a host vehicle from an adjacent lane, the cut-in vehicle may enter a position relatively close to the host vehicle. In such a case, near-field detection limitations of, for example, a millimeter-wave sensor of the host vehicle may cause the detection accuracy of the millimeter-wave sensor with respect to the cut-in vehicle to decrease, resulting in deceleration control of the host vehicle being inadequately performed.

The technology disclosed in the above patent publication detects a relative position of the cut-in vehicle relative to the host vehicle, and predicts the cut-in position, that is, a position at which the cut-in vehicle cuts in relative to the host vehicle, may be close to the host vehicle.

Unfortunately, the technology disclosed in the above patent publication may cause the detection accuracy of the relative position of the cut-in vehicle to decrease due to the close range between the cut-in vehicle and the host vehicle, resulting in the prediction accuracy of the cut-in position being likely to decrease. Controlling the deceleration of the host vehicle based on the low-accuracy cut-in position of the cut-in vehicle may result in inappropriate deceleration, i.e., excessive or insufficient deceleration, of the host vehicle.

In view of the above circumstances, the present disclosure seeks to provide vehicle control apparatuses and program products, each of which is capable of appropriately executing deceleration control of a host vehicle even when a cut-in vehicle enters a position that is relatively close to the host vehicle in front of the host vehicle.

An exemplary aspect of the present disclosure provides a vehicle control apparatus applicable to a host vehicle traveling in a host lane and including a detection device for detecting an object located around the host vehicle. The vehicle control apparatus includes an acquiring unit configured to acquire, from the detection device, detection information related to an external vehicle traveling in an adjacent lane that is adjacent to a host lane of the host vehicle and has a same traffic direction as the host lane. The vehicle control apparatus includes a close-range determiner configured to determine, upon the external vehicle cutting in front of the host vehicle, whether a cut-in state of the external vehicle is a close-range cut-in state in accordance with the detection information related to the external vehicle. The close-range cut-in state is defined as a state in which an inter-vehicle distance between the host vehicle and the external vehicle is smaller than at least one close-range determination value. The vehicle control apparatus includes a deceleration controller configured to control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

The vehicle control apparatus of the present disclosure is configured to determine, upon the external vehicle cutting in front of the host vehicle, whether a cut-in state of the external vehicle is a close-range cut-in state in accordance with the detection information related to the external vehicle. The close-range cut-in state is defined as a state in which an inter-vehicle distance between the host vehicle and the external vehicle is smaller than at least one close-range determination value. Then, the vehicle control apparatus is configured to control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

This configuration therefore makes it possible to, if a low-reliability condition of the inter-vehicle length due to reduced detection accuracy of the detection device continues in the close-range cut-in state of the external vehicle, adjust the deceleration of the host vehicle based on the continuation time. This therefore enables execution of adequate deceleration control of the host vehicle even if the external vehicle, which is located relatively close to the host vehicle, is cutting in front of the host vehicle.

### BRIEF DESCRIPTION OF THE DRAWINGS

Other aspects of the present disclosure will become apparent from the following description of embodiments with reference to the accompanying drawings in which:

FIG. 1 is a block diagram schematically illustrating a configuration of a driving assistance system of a host vehicle;

FIG. 2 is a schematic view illustrating an object detection range of a radar device mounted to the front end of a host vehicle;

FIG. 3 is a schematic view illustrating an example of such a cut-in situation of an external vehicle;

FIG. 4 is a schematic view illustrating an example of a close-range cut-in situation between the host vehicle and the external vehicle;

Each of FIGS. 5 and 6 is a diagram schematically illustrating (i) an example of map information and (ii) how a target deceleration is set using the map information;

FIG. 7 is a graph illustrating an example of correspondence information between a longitudinal distance and a jerk limit value;

FIG. 8 is a flowchart illustrating a deceleration control routine of the host vehicle;

FIG. 9 is a timing chart illustrating transition of each parameter in a separation scene; and

FIG. 10 is a timing chart illustrating transition of each parameter in an approach scene.

### DETAILED DESCRIPTION OF EMBODIMENTS

The following describes an embodiment of a vehicle control apparatus of the present disclosure with reference to accompanying drawings. In the present embodiment, a vehicle control apparatus is configured to constitute a driving assistance system for performing driving assistance of a vehicle CA, such as a passenger car, a truck, or a bus.

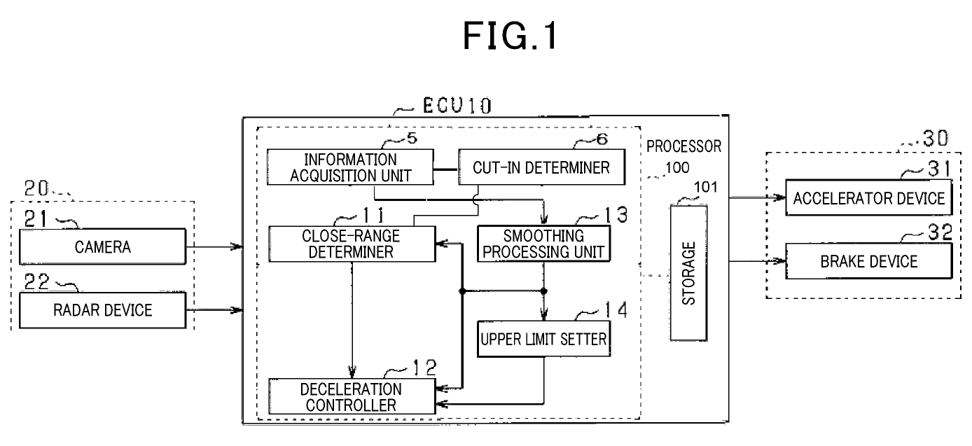

Referring to FIG. 1, the driving assistance system according to the present embodiment includes an electronic control unit (ECU) 10 serving as the driving control apparatus of the present embodiment, sensors 20, and controlled devices 30. The sensors 20 include cameras 21 and radar devices 22. The controlled devices 30 include an accelerator device 31 and brake devices 32.

Each camera 21 is, for example, a monocular camera. The cameras 21 includes a front camera for capturing images of a predetermined region located in front of the vehicle (host vehicle) CA, a rear camera for capturing images of a predetermined region located behind the host vehicle CA, a left-side camera for capturing images of a left-side region located on the left side of the host vehicle CA, and a right-side camera for capturing images of a right-side region located on the right side of the host vehicle CA. That is, the cameras 21 capture a surrounding region of the host vehicle CA. The front camera is mounted to an upper portion of the front windshield of the host vehicle CA or the front bumper or therearound of the host vehicle CA. Each camera 21 is configured to successively capture images of the corresponding region at predetermined time intervals (periods), and successively transmit the captured images to the ECU 10 at predetermined periods. Each image captured by each camera 21 is comprised of pixel values (i.e., light-intensity values), where each pixel value includes information regarding color and/or luminance. Each camera 21 may be a stereo camera.

Each radar device 22 is a distance measuring device using millimeter-wave high-frequency signals as transmitted waves. The radar devices 22 are respectively mounted to, for example, the front end, the rear end, the loft side, and the right side of the host vehicle CA.

Each radar device 22 includes a plurality of antennas, and is configured to transmit a probe wave at predetermined periods through at least one transmission antenna included in the antennas and receive, through receiving antennas included in the antennas, reflected waves (echoes) resulting from reflection of the probe waves by an object. Then, each radar device 22 is configured to measure a distance to the object in accordance with a transmission timing of the probe wave and a reception timing of at least one of the reflected waves. Additionally, each radar device 22 is configured to calculate an azimuth of the object with respect to the corresponding radar device 22 based on phase differences among the reflected waves received through the receiving antennas. Calculating the distance to the object and the azimuth of the object enables a relative position of the object with respect to the host vehicle CA to be identified.

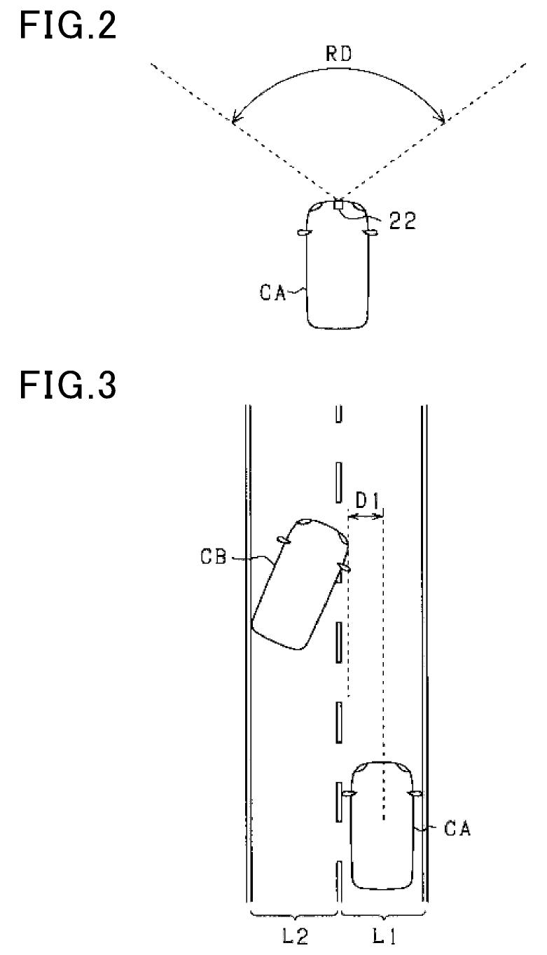

FIG. 2 illustrates an object detection range RD of the radar device 22 mounted to the front end of the host vehicle CA. In FIG. 2, the radar device 22 is mounted to the middle position of the front end of the host vehicle CA in the width direction of the host vehicle CA at a predetermined height. The object detection range RD is, for example, defined as a sector-shaped area extending radially forward with a predetermined central horizontal angle from the mount point as its origin. Furthermore, the sector-shaped area possesses a predetermined vertical field of view that accounts for the height of target objects to be detected. This enables each radar device 22 to detect road surfaces, target vehicles, and/or obstacles located within the object detection area RD.

The ECU 10 includes a microcomputer provided with a processor, i.e., a CPU, 100 and a storage 101 including, for example, a RAM, a ROM, and a non-volatile rewritable memory. The microcomputer, i.e., the processor 100, provides various computing functions. The various computing functions that can be provided by the microcomputer may be implemented by (i) software stored in a non-volatile tangible memory, (ii) hardware, such as one or more computers (processors), or (iii) the combinations of the software and the hardware.

Specifically, the processor 100 reads and executes computer programs, i.e., computer-program instructions, stored in the storage 101, such as the corresponding ROM or the non-volatile rewritable memory. Each of the ROM and the non-volatile rewritable memory serves as a non-transitory tangible storage medium. The programs include, for example, a program that causes the processor 100 to execute an object recognition process of recognizing one or more objects around the host vehicle CA, and a program that causes the processor 100 to execute a collision avoidance process of avoiding a collision of the host vehicle CA with objects and/or a collision mitigation process of mitigating damage in collision of the host vehicle CA with an object. The processor 100, which executes the programs, enables execution of corresponding respective methods. The programs stored in the storage 101 may be updated through a network, such as the Internet.

The ECU 10 acquires object-related information related to an object located around the host vehicle CA from each of the cameras 21 and the radar devices 22, and recognizes, based on the acquired object-related information, at least one object around the host vehicle CA. Specifically, the ECU 10 acquires the captured images from the cameras 21 and obtains image-related information including a distance and an azimuth of at least one image-based object based on the captured images. Then, the ECU 10 fuses the image-related information and the radar-related information that includes information related to the distance and the azimuth of at least one radar-based object measured by at least one of the radar devices 22, thus recognizing at least one object around the host vehicle CA. The ECU 10 can be configured to recognize at least one object around the host vehicle CA based on only the object-related information acquired by the cameras 21 or only the object-related information acquired by the radar devices 22.

The ECU 10 is configured to execute, as driving assistance control of the host vehicle CA, Adaptive Cruise Control (ACC). The ACC is designed to cause the host vehicle CA to travel at a constant speed based on a target speed set by the driver, and cause, when a preceding vehicle is present in front of the host vehicle CA in its direction of travel, the host vehicle CA to follow the preceding vehicle while maintaining a predetermined inter-vehicle distance between the preceding vehicle and the host vehicle CA.

The ECU 10 searches for a preceding vehicle as a following target along the travel path of the host vehicle CA during ACC execution. Upon determining that no preceding vehicle is located along the travel path of the host vehicle CA, the ECU 10 causes the host vehicle CA to travel at a constant speed based on the target speed set by the driver. Otherwise, upon determining that a preceding vehicle is located along the travel path of the host vehicle CA, the ECU 10 causes the host vehicle CA to travel while maintaining a predetermined target inter-vehicle distance between the preceding vehicle and the host vehicle CA. During execution of the ACC, the ECU 10 controls the controlled devices 30 to thereby execute speed control of the host vehicle CA.

The controlled vehicles 30 installed in the host vehicle CA include the accelerator device 31 and the brake devices 32. The accelerator device 31 is, for example, an engine and at least one motor for generating driving force of the host vehicle CA. The ECU 10 instructs, based on a driver’s operation of an accelerator pedal of the host vehicle, the accelerator device 31 to apply driving force to the host vehicle CA. The brake devices 32 are provided for, for example, the respective wheels of the host vehicle CA. The ECU 10 instructs, based on a driver’s operation of a brake pedal of the host vehicle CA, the brake devices 32 apply braking force to the host vehicle CA.

The host vehicle includes an on/off switch to activate or deactivate the ACC. When the driver activates the on/off switch, the ECU 10 executes the ACC. The ECU 10 terminates the ACC when a predetermined cancellation condition is satisfied, such as the driver deactivating the on/off switch.

The ECU 10 of the present embodiment is configured to execute, as the driving assistance control of the host vehicle CA, deacceleration control of the host vehicle CA. The deacceleration control is designed to deaccelerate the host vehicle CA in a cut-in situation (cutting-in scene) where (i) the host vehicle CA is traveling in a lane (i.e., a host lane), and (ii) an external vehicle traveling in an adjacent lane, which is adjacent to the host lane and has the same traffic direction as the host lane, is cutting in front of the host vehicle CA.

For example, as illustrated in FIG. 1, the ECU 10 includes, as a configuration for performing the deceleration control of the host vehicle CA in such a cut-in situation, an information acquisition unit 5, a cut-in determiner 6, and a deceleration controller 12.

The information acquisition unit 5 acquires the object-related information related to an external vehicle CB traveling in the adjacent lane detected by at least one camera 21 and/or at least one radar device 22.

The cut-in determiner 6 determines, based on the object-related information on an external vehicle CB acquired by the information acquisition unit 5, whether the external vehicle CB is cutting in front of the host vehicle CA.

FIG. 3 illustrates an example of such a cut-in situation of an external vehicle CB. In the cut-in situation illustrated in FIG. 3, the host vehicle CA is traveling in a host lane L1 of a road and the external vehicle CB is traveling in an adjacent lane L2 of the road. Additionally, in the cut-in situation illustrated in FIG. 3, the external vehicle CB is moving in a lateral direction perpendicular to the forward direction of the host vehicle CA into the host lane L1 so as to cut in front of the host vehicle CA.

The cut-in determiner 6 of the ECU 10 determines, for the deceleration control of the host vehicle CA, whether the external vehicle CB is cutting in front of the host vehicle CA in accordance with the object-related information on the external vehicle CB acquired by the information acquisition unit 5. The cut-in determiner 6 of the ECU 10 is designed to be capable of employing at least one of the following first to third methods for determining whether the external vehicle CB is cutting in front of the host vehicle CA.

### (A) First method

In the first method, the cut-in determiner 6 of the ECU 10 recognizes left and right lane markings, such as white lines, of the host lane L1 and determines whether the external vehicle CB traveling in the adjacent lane L2 has moved laterally and reached the lane marking between the host lane L1 and the adjacent lane L2 (hereinafter referred to as a “boundary lane marking”). When the cut-in determiner 6 of the ECU 10 determines that the external vehicle CB has reached the boundary lane marking between the lanes L1 and L2 in the lateral direction, the ECU 10 determines that the external vehicle CB is cutting in front of the host vehicle CA.

Preferably, a lane marking on a road surface may be recognized based on luminance changes, i.e., pixel-value changes, in an image, which includes the road surface in front of the host vehicle CA, captured by the front camera 21. Specifically, for a lane marking such as a white line, the cut-in determiner 6 of the ECU 10 extracts points where luminance on the road surface included in the captured image changes as edge candidate points (i.e., points of change in contrast or edge intensity). Then, the cut-in determiner 6 of the ECU extracts the lane marking from a sequence of the extracted edge candidate points.

Whether the external vehicle CB traveling in the adjacent lane L2 has moved laterally and reached the boundary lane marking between the lanes L1 and L2 may be determined based on analysis of an image, which includes the road surface in front of the host vehicle CA, captured by the front camera 21. Preferably, when a portion of the external vehicle CB closest to the host lane L1 (for example, a front-right corner of the external vehicle CB or a front wheel position of the external vehicle CB on the host-vehicle side) is determined to intersect the boundary lane marking between the lanes L1 and L2, the cut-in determiner 6 of the ECU 10 may determine that the external vehicle CB is in a situation of cutting in front of the host vehicle CA.

### (B) Second method

In the second method, the cut-in determiner 6 of the ECU 10 calculates a lateral distance D1 (see FIG. 3) from the host vehicle CA to the external vehicle CB. The lateral distance D1 is defined as a minimum lateral distance between an extension of the longitudinal centerline of the host vehicle CA and a portion of the external vehicle CB closest to the host vehicle CA.

Then, the cut-in determiner 6 of the ECU 10 determines whether the lateral distance D1 becomes equal to or less than a predetermined cut-in determination value, and, when determining that the lateral distance D1 becomes equal to or less than the predetermined cut-in determination value, the cut-in determiner 6 of the ECU 10 determines that the external vehicle CB is cutting in front of the host vehicle CA. The cut-in determination value is, for example, a value defined as a minimum distance from a lateral center position of the host lane L1 to the boundary lane marking between the host lane L1 and the adjacent lane L2 when the boundary lane marking is recognized.

### (C) Third method

In the third method, the cut-in determiner 6 of the ECU 10 determines whether the external vehicle CB is cutting in front of the host vehicle CA based on the lateral distance D1 and a yaw inclination of the external vehicle CB relative to the traveling direction of the host vehicle CA. For example, the cut-in determiner 6 of the ECU 10 may estimate, on an image including the road surface in front of the host vehicle CA and captured by the front camera 21, the yaw inclination of the external vehicle CB based on an angle formed between the closer side surface of the external vehicle CB to the host vehicle CA and the boundary lane marking between the lanes L1 and L2. Alternatively, the cut-in determiner 6 of the ECU 10 may acquire information on the yaw inclination of the external vehicle CB through vehicle-to-vehicle communication between the host vehicle CA and the external vehicle CB or vehicle-to-infrastructure communication with a roadside device.

For example, when the yaw inclination of the external vehicle CB is ±20 degrees or more, the cut-in determiner 6 of the ECU 10 may determine that the external vehicle CB is cutting in front of the host vehicle CA.

When determining, in deceleration control of the host vehicle CA, that the external vehicle CB is cutting in front of the host vehicle CA, the deceleration controller 12 of the ECU 10 controls the accelerator device 31 and/or the brake device 32 to thereby adjust the braking force of the host vehicle CA, thus preventing a collision of the host vehicle CA with the cut-in vehicle CB.

When an external vehicle CB is cutting in front of the host vehicle CA, a cut-in position of the external vehicle CB is likely to be relatively close to the host vehicle CA. For example, when the host vehicle CA is traveling at a low speed, the external vehicle CB traveling in the adjacent lane may forcefully cut in at a position close to the host vehicle CA. In such a case, detection accuracy of the cut-in vehicle CB may decrease due to the close range between the host vehicle CA and the cut-in vehicle CB, resulting in speed control of the host vehicle CA being inappropriately performed.

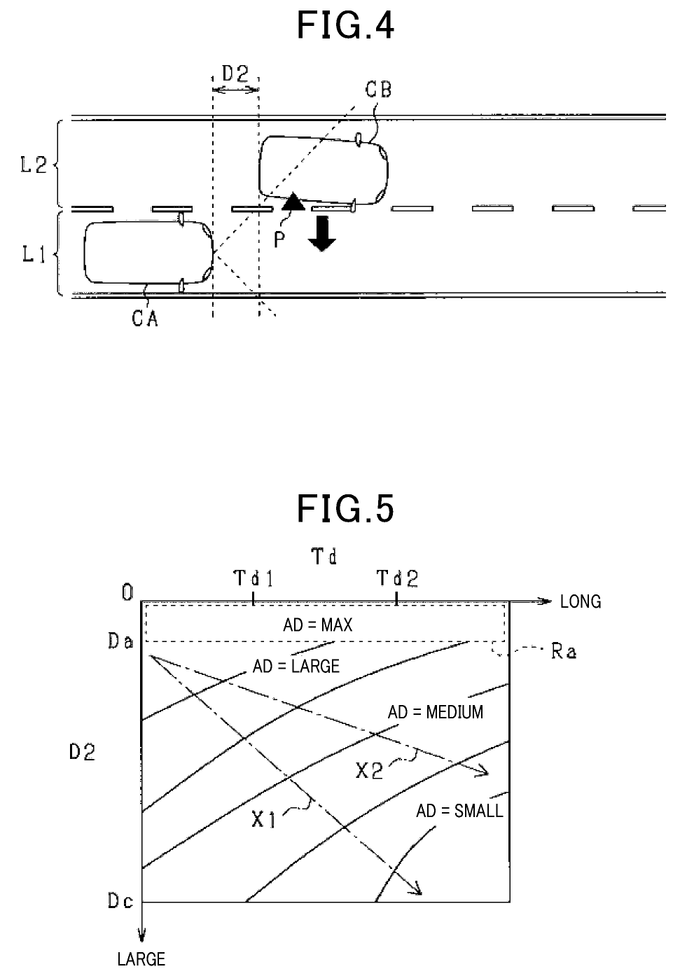

For example, FIG. 4 illustrates an example of such a close-range cut-in situation (scene) between the host vehicle CA traveling in the host lane L1 and the external vehicle CB traveling in the adjacent lane L2. In this close-range cut-in situation shown in FIG. 4, only a part of the external vehicle CB traveling in the adjacent lane L2 enters a detection range RD of the radar device 22 of the host vehicle CA, and a radar-based object detection point P is formed on the closer side surface of the external vehicle CB. In this case, because the object detection point P on the closer side surface of the external vehicle CB may vary in the longitudinal direction of the external vehicle CB, it may be difficult to correctly grasp a relative position and a relative speed of the external vehicle CB with respect to the host vehicle CA. As a result, deceleration control of the host vehicle CA may not be properly performed when the external vehicle CB is cutting in front of the host vehicle CA.

Even when the external vehicle CB is detected from an image captured by at least one of the cameras 21, the external vehicle CB may be partially captured (i.e., partially truncated) in the captured image, which may reduce object recognition accuracy based on pattern matching or the like, resulting in decrease in the accuracy of deceleration control of the host vehicle CA. For example, in conventional approaches, in order to avoid deterioration in control accuracy during such a close-range cut-in, a configuration may be employed in which deceleration control for the cut-in external vehicle is not executed in such a close-range situation.

From the above viewpoint, the ECU 10 of the present embodiment includes a close-range determiner 11 in addition to the deceleration controller 12 as a configuration for appropriately performing deceleration control in such a close-range cut-in situation (scene).

The close-range determiner 11 determines, when it is determined that an external vehicle CB is cutting in front of the host vehicle CA, whether the cut-in state of the external vehicle CB is a close-range cut-in state (corresponding to a “close-range state”). The close-range cut-in state is defined as a state in which a longitudinal distance D2 (i.e., an inter-vehicle distance, see FIG. 4) between the host vehicle CA and the external vehicle CB cutting in front of the host vehicle CA is smaller than at least one predetermined close-range determination value. The cut-in determiner 6 or the close-range determiner 11 may calculate the longitudinal distance D2 based on the object-related information on the external vehicle CB acquired by the information acquisition unit 6.

The at least one close-range determination value according to the present embodiment includes a first close-range determination value Dk and a cancel determination value Dc. The first close-range determination value Dk is set to a value less than for example 15 m, and more specifically to 10 m. The cancel determination value Dc is set to a value larger than the first close-range determination value Dk, such as to 15 m.

Upon determining that the cut-in state of the external vehicle CB is not the close-range cut-in state, the close-range determiner 11 determines whether a start condition that the longitudinal distance D2 is smaller than the first close-range determination value Dk is satisfied. Upon determining that the start condition is satisfied, the close-range determiner 11 switches the determination that the cut-in state of the external vehicle CB is not the close-range cut-in state to the determination that the cut-in state of the external vehicle CB is the close-range cut-in state. Otherwise, upon determining that the start condition is not satisfied, the close-range determiner 11 continues the determination that the cut-in state of the external vehicle CB is not the close-range cut-in state.

Upon determining that the cut-in state of the external vehicle CB is the close-range cut-in state, the close-range determiner 11 determines whether a cancel condition that the longitudinal distance D2 is greater than the cancel determination value Dc is satisfied. Upon determining that the cancel condition is not satisfied, the close-range determiner 11 continues the determination that the cut-in state of the external vehicle CB is the close-range cut-in state. Otherwise, upon determining that the cancel condition is satisfied, the close-range determiner 11 switches the determination that the cut-in state of the external vehicle CB is the close-range cut-in state to the determination that the cut-in state of the external vehicle CB is not the close-range cut-in state.

That is, the close-range determiner 11 is configured to determine whether the cut-in state of the external vehicle CB is the close-range cut-in state using the determination values Dk and Dc. This configuration makes it possible to suppress the occurrence of hunting, where (i) the determination that the cut-in state of the external vehicle CB is not the close-range cut-in state and (ii) the determination that the cut-in state of the external vehicle CB is the close-range cut-in state are repeated.

The deceleration controller 12 counts a continuation time Td during which the close-range determiner 11 continuously determines that the cut-in state of the external vehicle CB is the close-range cut-in state.

Specifically, in response to the determination that the cut-in state of the external vehicle CB is not the close-range cut-in state being switched to the determination that the cut-in state of the external vehicle CB is the close-range cut-in state, the deceleration controller 12 starts counting the continuation time Td from an initial value of, for example, 0. While the close-range determiner 11 determines that the cut-in state of the external vehicle CB is the close-range cut-in state, the deceleration controller 12 increments the continuation time Td. In response to the determination that the cut-in state of the external vehicle CB is the close-range cut-in state being switched to the determination that the cut-in state of the external vehicle CB is not the close-range cut-in state, the deceleration controller 12 resets the continuation time Td to the initial value.

When the close-range determiner 11 determines that the cut-in state of the external vehicle CB is the close-range cut-in state, the deceleration controller 12 sets a target deceleration AD of the host vehicle CA in the deceleration control based on the longitudinal distance D2 and the continuation time Td. The deceleration controller 12 controls the accelerator device 31 and/or the brake device 32 to adjust the braking force of the host vehicle CA, thus causing the deceleration of the host vehicle CA to become the target deceleration AD.

The target deceleration AD of the host vehicle CA according to the present embodiment is set as a target acceleration having a negative value. In this setting, an increase in the target deceleration AD corresponds to a decrease in the target acceleration having the negative value, and a decrease in the target deceleration AD corresponds to an increase in the target acceleration within the negative range.

The following describes, in detail, a method of setting the target deceleration AD.

The deceleration controller 12 sets the target deceleration AD based on the longitudinal distance D2 calculated from (i) the object-related information acquired by at least one camera 21 and/or at least one radar device 22, (ii) a current value of the continuation time Td, and (iii) association information in which the longitudinal distance D2, the continuation time Td, and the target deceleration AD are associated with each other. The association information according to the present embodiment is map information. The association information may alternatively be formula information.

Each of FIGS. 5 and 6 shows an example of the map information in which the longitudinal distance D2, the continuation time Td, and the target deceleration AD are associated with each other. The map information is stored beforehand in the storage 101.

In the illustrated example, the horizontal axis represents the continuation time Td, and the vertical axis represents the longitudinal distance D2. The map information schematically represents a relationship among the longitudinal distance D2, the continuation time Td, and the target deceleration AD, and the illustrated curves indicate representative relative magnitudes (levels) of the target deceleration AD. For example, selected curves in the illustrated curves indicate relative magnitudes “AD = LARGE”, “AD = MEDIUM”, and “AD = SMALL”, of the target deceleration AD.

The deceleration controller 12 sets the target deceleration AD based on a position defined by a current value of the current longitudinal distance D2 and a current value of the continuation time Td on the map information.

During continuation of the close-range cut-in state, the longitudinal distance D2 between the host vehicle CA and the external vehicle CB may either increase or decrease.

FIG. 5 additionally illustrates how the target deceleration AD is set in a separation scene in which the longitudinal distance D2 increases as the continuation time Td increases, whereas FIG. 6 additionally illustrates how the target deceleration AD is set in an approach scene in which the longitudinal distance D2 decreases as the continuation time Td increases.

In the separation scene, when the continuation time Td is relatively short, the inter-vehicle distance (longitudinal distance) D2 between the host vehicle CA and the external vehicle CB is relatively short and recognition of the external vehicle CB may be unstable. This may result in a possibility of collision of the host vehicle CA with the external vehicle CB being relatively high.

On the other hand, when the continuation time Td becomes longer, the inter-vehicle distance (longitudinal distance) D2 increases due to elapse of time from the start of the cut-in by the external vehicle CB, and thus the possibility of collision of the host vehicle CA with the external vehicle CB decreases. However, unnecessary deceleration of the host vehicle CA may occur if the deceleration control continues excessively. From this viewpoint, the map information shown in FIG. 5 is configured such that, in the separation scene, the target deceleration AD is set to a smaller value as the continuation time Td becomes longer.

The deceleration controller 12 sets an initial deceleration level of the target deceleration AD each time when the determination that the cut-in state of the external vehicle CB is not the close-range cut-in state is switched to the determination that the cut-in state of the external vehicle CB is the close-range cut-in state, i.e., at the timing when the continuation time Td is reset to the initial value of 0.

The deceleration controller 12 of the present embodiment sets the initial deceleration level of the target deceleration AD to a predetermined fixed deceleration level. The fixed deceleration level is, for example, a maximum deceleration level among deceleration levels of the target deceleration AD that can be set in the deceleration control of the host vehicle CA. The maximum deceleration level of the target deceleration AD in the deceleration control is, for example, −0.1 G. Note that the maximum deceleration level of the target deceleration AD in the deceleration control is smaller in magnitude than a maximum deceleration level of the target deceleration AD that can be set in the ACC control. The maximum deceleration level of the target deceleration AD in the ACC control is, for example, −0.5 G.

After setting the initial deceleration level of the target deceleration AD, the deceleration controller 12 sets the target deceleration AD based on the longitudinal distance D2 and the continuation time Td when a continuation-time dependent adjustment condition is satisfied. The adjustment condition is that the longitudinal distance D2 is greater than a second close-range determination value Da and smaller than the cancel determination value Dc, which is represented by the relational expression Da < D2 < Dc. The second close-range determination value Da is set to be smaller than the first close-range determination value Dk.

More specifically, when the adjustment condition Da < D2 < Dc is satisfied, the deceleration controller 12 is configured to set, in the separation scene illustrated in FIG. 5, the target deceleration AD to a smaller value as the continuation time Td becomes longer, on condition that the longitudinal distance D2 remains stable or increases during counting of the continuation time Td.

In FIG. 5, each of one-dot chain lines X1 and X2 represents an example trajectory showing how the longitudinal distance D2 changes over time as the continuation time Td increases in a corresponding one of typical first and second separation scenes.

Specifically, as illustrated by the one-dot chain line X1, a value of the target deceleration AD at a second value Td2 of the continuation time Td is set to be smaller than a value of the target deceleration AD at a first value Td1 of the continuation time Td in the first separation scene. Similarly, as illustrated by the one-dot chain line X2, a value of the target deceleration AD at the second value Td2 of the continuation time Td is set to be smaller than a value of the target deceleration AD at the first value Td1 of the continuation time Td in the second separation scene.

When the longitudinal distance D2 increases during counting of the continuation time Td, the deceleration controller 12 sets a smaller value of the target deceleration AD as a degree of increase in the longitudinal distance D2 becomes larger. For example, in the first separation scene X1 in which the degree of increase in the longitudinal distance D2 is greater than that in the second separation scene X2, the target deceleration AD at the same continuation time Td (for example, the first continuation time Td1) is set to a smaller value than in the separation scene X2.

This configuration makes it possible to reduce, in the close-range cut-in state, the host vehicle's deceleration faster in cases where the longitudinal distance D2 increases rapidly, compared to cases where it increases slowly. This appropriately suppresses unnecessary deceleration during the separation scene.

In the approach scene in which the longitudinal distance D2 decreases as the continuation time Td increase, it is desirable to increase the deceleration of the host vehicle CA in order to reduce a possibility of collision of the host vehicle CA with the external vehicle CB. From this viewpoint, the map information shown in FIG. 6 is configured such that, in the approach scene, the target deceleration AD is set to a greater value as the continuation time Td becomes longer.

More specifically, when the adjustment condition Da < D2 < Dc is satisfied, the deceleration controller 12 is configured to set, in the approach scene illustrated in FIG. 6, the target deceleration AD to a larger value as the continuation time Td becomes longer, on condition that the longitudinal distance D2 decreases during counting of the continuation time Td.

In FIG. 6, each of one-dot chain lines Y1 and Y2 represents an example trajectory showing how the longitudinal distance D2 changes over time as the continuation time Td increases in a corresponding one of typical first and second approach scenes.

Specifically, as illustrated by the one-dot chain line Y1, a value of the target deceleration AD at the second value Td2 of the continuation time Td is set to be greater than a value of the target deceleration AD at the first value Td1 of the continuation time Td in the first approach scene. Similarly, as illustrated by the one-dot chain line Y2, a value of the target deceleration AD at the second value Td2 of the continuation time Td is set to be greater than a value of the target deceleration AD at the first value Td1 of the continuation time Td in the second approach scene.

When the longitudinal distance D2 decreases during counting of the continuation time Td, the deceleration controller 12 sets a greater value of the target deceleration AD as a degree of decrease in the longitudinal distance D2 becomes larger. For example, in the first approach scene Y1 in which the degree of decrease in the longitudinal distance D2 with respect to the continuation time Td is greater than that in the second approach scene Y2, the target deceleration AD at the same continuation time Td (for example, the first continuation time Td1) is set to a greater value than in the second approach scene Y2.

This configuration makes it possible to apply, in the close-range cut-in state, a greater level of deceleration to the host vehicle CA in cases where the longitudinal distance D2 increases rapidly, compared to cases where it increases slowly. This appropriately reduces the possibility of collision of the host vehicle CA with the external vehicle CB.

On the other hand, when the adjustment condition Da < D2 < Dc is not satisfied, for example, the longitudinal distance D2 is greater than or equal to 0 and smaller than or equal to the second close-range determination value Da, the deceleration controller 12 is configured to set the target deceleration AD to a maximum deceleration level among the deceleration levels that can be set in the deceleration control, regardless of the continuation time Td.

This configuration makes it possible to apply a sufficiently large level of deceleration to the host vehicle CA in a situation where the external vehicle CB is approaching the host vehicle CA at a close-range, thus suitably reducing the likelihood of collision of the host vehicle CA with the external vehicle CB during the close-distance cut-in state.

Next, the following describes a specific configuration of the ECU 10 for further appropriately performing the deceleration control of the host vehicle CA in the close-range cut-in situation.

The ECU 10 includes a smoothing processing unit 13 and an upper limit setter 14.

The smoothing processing unit 13 retrieves, from the information acquisition unit 6, the object-related information on the external vehicle CB acquired by the information acquisition unit 6, and performs a smoothing process of suppressing fluctuations in the retrieved object-related information on the external vehicle CB. The smoothing process may be, for example, first-order lag filtering. The object-related information on the external vehicle CB to be smoothed is information used in the deceleration control, specifically the longitudinal distance D2.

The longitudinal distance D2, which has been subjected to the smoothing process, is input to the close-distance determiner 11 and the deceleration controller 12.

That is, strictly speaking, the close-distance determiner 11 determines whether the cut-in state of the external vehicle CB is the close-range cut-in state based on the smoothed longitudinal distance D2, and the deceleration controller 12 sets the target deceleration AD based on the smoothed longitudinal distance D2. While the previous sections omitted this for simplicity, this filtering makes it possible to ensure stable vehicle behavior during the deceleration control of the host vehicle CA.

The smoothed longitudinal distance D2 is also input to the upper limit setter 14.

The upper limit setter 14 sets a jerk limit value J for limiting the jerk of the host vehicle CA based on the longitudinal distance D2. The jerk of the host vehicle CA in the present embodiment is the rate of change of deceleration of the host vehicle CA per unit time. In other words, the jerk of the host vehicle CA in the present embodiment is a time rate of change of deceleration of the host vehicle CA. The jerk limit value J set by the upper limit setter 14 is input to the deceleration controller 12.

The deceleration controller 12 is configured to control the accelerator device 31 and/or the brake device 32 to adjust the braking force of the host vehicle CA, thus causing the deceleration of the host vehicle CA to become the target deceleration AD while maintaining the jerk of the host vehicle CA to be lower than or equal to the jerk limit value J. This makes it possible to, even if reliability of the longitudinal distance D2 decreases due to reduced detection accuracy in the close-range cut-in state, suppress instability in the deceleration control of the host vehicle CA.

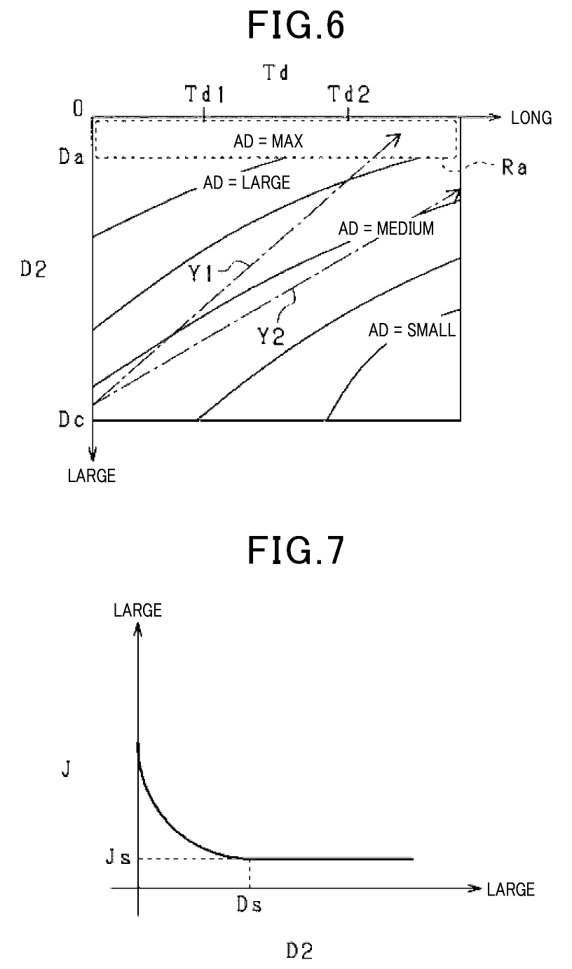

FIG. 7 is a graph illustrating an example of correspondence information between the longitudinal distance D2 and the jerk limit value J, which is used to set the jerk limit value J. When the longitudinal distance D2 is relatively small, the likelihood of collision of the host vehicle CA with the external vehicle CB is relatively high, and thus a relatively large level of deceleration of the host vehicle CA may be required. In this case, the jerk during the deceleration control of the host vehicle CA may also become relatively large.

In contrast, when the longitudinal distance D2 is relatively large, the likelihood of collision of the host vehicle CA with the external vehicle CB is relatively low, and thus a relatively small level of deceleration of the host vehicle CA may be required. In this case, the jerk during the deceleration control of the host vehicle CA may also become relatively small.

From this viewpoint, upon determining that the longitudinal distance D2 is greater than a predetermined threshold distance Ds, the upper limit setter 14 sets the jerk limit value J to a predetermined limit value Js. In contrast, upon determining that the longitudinal distance D2 is smaller than or equal to the predetermined threshold distance Ds, the upper limit setter 14 sets the jerk limit value J to an arbitrary value greater than the predetermined limit value Js.

This configuration of the upper limit setter 14 makes it possible to suppress unnecessary deceleration of the host vehicle CA when the longitudinal distance D2 is relatively large, and suppress excessive restriction of deceleration of the host vehicle CA when the longitudinal distance D2 is relatively small.

When the longitudinal distance D2 is smaller than or equal to or the predetermined threshold distance Ds, the upper limit setter 14 gradually increases the jerk limit value J as the longitudinal distance D2 decreases. This configuration of the upper limit setter 14 makes it possible to balance suppression of unnecessary deceleration of the host vehicle CA and avoidance of excessive restriction of the deceleration control of the host vehicle CA.

Executing the smoothing process enables the influence of reduced detection accuracy of the cameras 21 and/or the radar devices 22 in the close-distance cut-in state on the deceleration control and jerk-limit setting of the host vehicle CA to be reduced. For example, in the close-distance cut-in scene shown in FIG. 4, the smoothing process makes it possible to suppress instability of the longitudinal distance D2 caused by detection-point variations of the external vehicle CB in its longitudinal direction.

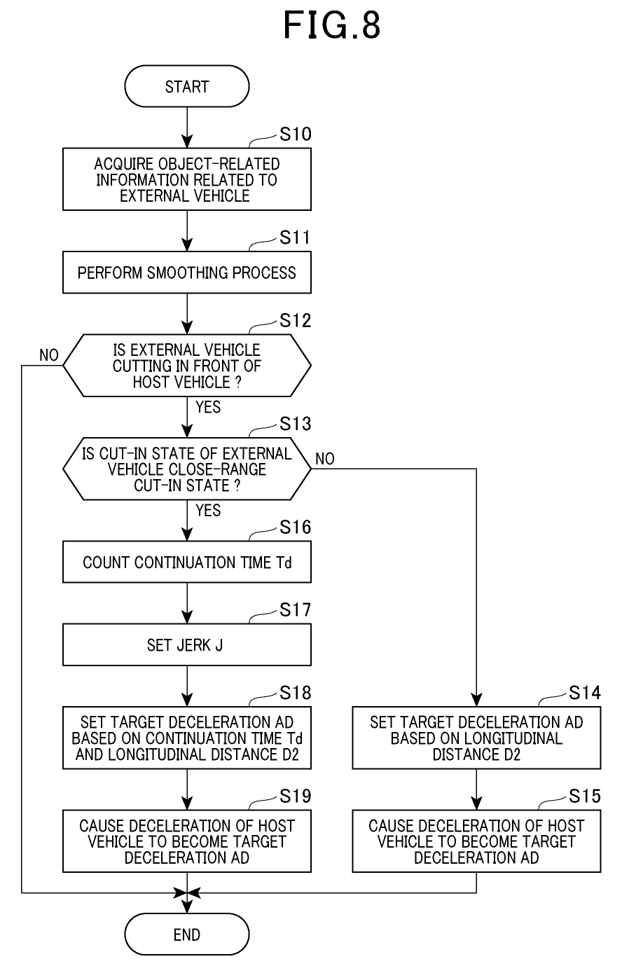

FIG. 8 is a flowchart illustrating a deceleration control routine of the host vehicle CA. The processor 100 of the ECU 10 is configured to cyclically execute the deceleration control routine at predetermined intervals.

When starting a current cycle of the deceleration control routine, the processor 100 serves as, for example, the information acquisition unit 5 to acquire the object-related information on an external vehicle CB traveling in the adjacent lane detected by at least one camera 21 and/or at least one radar device 22 in step S10.

In step S10, the processor 100 serves as, for example, the cut-in determiner 6 to calculate, based on the object-related information on the external vehicle CB, the lateral distance D1 from the host vehicle CA to the external vehicle CB, and the longitudinal distance D2 between the host vehicle CA and the external vehicle CB cutting in front of the host vehicle CA.

Next, the processor 100 serves as, for example, the smoothing processing unit 13 to perform the smoothing process of smoothing a current value of the longitudinal distance D2 calculated in the current cycle of the deceleration control routine based on a previous value of the longitudinal distance D2 calculated in the immediately previous cycle of the deceleration control routine in step S11.

Following the operation in step S11, the processor 100 serves as, for example, the cut-in determiner 6 to determine whether the external vehicle CB is cutting in front of the host vehicle CA in accordance with the object-related information on the external vehicle CB acquired by the information acquisition unit 5 in step S12.

Upon determination the external vehicle CB is not cutting in front of the host vehicle CA (NO in step S12), the processor 100 terminates the current cycle of the deceleration control routine.

Otherwise, upon determination that the external vehicle CB is cutting in front of the host vehicle CA (YES in step S12), the deceleration control routine proceeds to step S13.

In step S13, the processor 100 serves as, for example, the close-range determiner 11 to execute

(I) A first determination of determining whether the cut-in state of the external vehicle CB has been determined to be the close-range cut-in state;

(II) A second determination of determining, when it is determined that the cut-in state of the external vehicle CB has not been determined to be the close-range cut-in state, whether the start condition is satisfied; and

(III) A third determination of determining, when it is determined that the cut-in state of the external vehicle CB has been determined to be the close-range cut-in state, whether the cancel condition is satisfied.

Upon determination that the start condition is satisfied when it is determined that the cut-in state of the external vehicle CB has not been determined to be the close-range cut-in state (YES in the second determination), the processor 100 switches the determination that the cut-in state of the external vehicle CB is not the close-range cut-in state to the determination that the cut-in state of the external vehicle CB is the close-range cut-in state (YES in step S13). Then, the deceleration control routine proceeds to step S16.

Otherwise, upon determination that the start condition is not satisfied when it is determined that the cut-in state of the external vehicle CB has not been determined to be the close-range cut-in state (NO in the second determination), the processor 100 maintains the determination that the cut-in state of the external vehicle CB is not the close-range cut-in state (NO in step S13). Then, the deceleration control routine proceeds to step S14.

Upon determination that the cancel condition is satisfied when it is determined that the cut-in state of the external vehicle CB has been determined to be the close-range cut-in state (YES in the third determination), the processor 100 switches the determination that the cut-in state of the external vehicle CB is the close-range cut-in state to the determination that the cut-in state of the external vehicle CB is not the close-range cut-in state (NO in step S13). Then, the deceleration control routine proceeds to step S14.

Otherwise, upon determination that the cancel condition is not satisfied when it is determined that the cut-in state of the external vehicle CB has been determined to the close-range cut-in state (NO in the third determination), the processor 100 maintains the determination that the cut-in state of the external vehicle CB is the close-range cut-in state (YES in step S13). Then, the deceleration control routine proceeds to step S16.

In step S14, the processor 100 serves as, for example, the deceleration controller 12 to set the target deceleration AD of the host vehicle CA based on the longitudinal distance D2, which has been subjected to the smoothing process, without using the continuation time Td. In step S14, the processor 100 may set the target deceleration AD of the host vehicle CA based on the longitudinal distance D2 and the relative speed between the host vehicle CA and the external vehicle CB; the relative speed is included in the object-related information on the external vehicle CB.

Following the operation in step S14, the processor 100 serves as, for example, the deceleration controller 12 to control the accelerator device 31 and/or the brake device 32 to adjust the braking force of the host vehicle CA, thus causing the deceleration of the host vehicle CA to become the target deceleration AD in step S15. In step S15, the processor 100 may adjust the braking force of the host vehicle CA to cause the jerk of the host vehicle CA to be smaller than or equal to a predetermined value.

In step S16, the processor 100 serves as, for example, the deceleration controller 12 to count the continuation time Td.

Specifically, the processor 100 starts counting the continuation time Td from 0 in response to YES in the second determination, i.e., in response to switching the determination that the cut-in state of the external vehicle CB is not the close-range cut-in state to the determination that the cut-in state of the external vehicle CB is the close-range cut-in state. Additionally, the processor 100 increments the continuation time in response to NO in the third determination, i.e., in response to the determination that the cut-in state of the external vehicle CB is the close-range cut-in state being maintained.

Note that, upon determination the external vehicle CB is not cutting in front of the host vehicle CA (NO in step S12) after the start of counting the continuation time Td, the processor 100 resets the continuation time Td to 0. Similarly, in response to the negative determination in step S13 after the start of counting the continuation time Td, the processor 100 resets the continuation time Td to 0.

Next, the processor 100 serves as, for example, the upper limit setter 14 to set the jerk limit value J based on the longitudinal distance D2, which has been subjected to the smoothing process in step S17.

Following the operation in step S17, the processor 100 serves as, for example, the deceleration controller 12 to set the target deceleration AD of the host vehicle CA based on the continuation time Td and the longitudinal distance D2, which has been subjected to the smoothing process in step S18.

In particular, the processor 100 serves as, for example, the deceleration controller 12 to change the target deceleration AD of the host vehicle CA from the initial deceleration level to a lower deceleration level or a greater deceleration level when the continuation time Td reaches a predetermined count value Tda.

In particular, the processor 100 serves as, for example, the deceleration controller 12 to change the target deceleration AD of the host vehicle CA from the initial deceleration level to a lower deceleration level on condition that the longitudinal distance D2 increases before the continuation time Td reaches and exceeds the predetermined count value Tda.

Additionally, the processor 100 serves as, for example, the deceleration controller 12 to change the target deceleration AD of the host vehicle CA from the initial deceleration level to a greater deceleration level on condition that the longitudinal distance D2 decreases before the continuation time Td reaches and exceeds the predetermined count value Tda.

Following the operation in step S18, the processor 100 serves as, for example, the deceleration controller 12 to control the accelerator device 31 and/or the brake device 32 to adjust the braking force of the host vehicle CA, thus causing (i) the deceleration of the host vehicle CA to become the target deceleration AD and (ii) the jerk of the host vehicle CA to be smaller than or equal to the jerk limit value J in step S19.

After the operation in step S15 or step S19, the processor 100 terminates the current cycle of the deceleration control routine.

The ECU 10 of the present embodiment is configured to determine, when it is determined that the external vehicle CB traveling in the adjacent lane L2 is cutting in front of the host vehicle CA traveling in the host lane L1, whether the cut-in state of the external vehicle CB is the close-range cut-in state.

In response to determination that the cut-in state of the external vehicle CB is the close-range cut-in state, the ECU 10 is configured to control the deceleration of the host vehicle CA in the deceleration control based on the continuation time Td during which it is continuously determined that the cut-in state of the external vehicle CB is the close-range cut-in state.

This configuration makes it possible to, if a low-reliability condition of the longitudinal length D2 due to reduced detection accuracy of the cameras 21 and/or the radar devices 22 continues in the close-range cut-in state of the external vehicle CB, adjust the deceleration of the host vehicle CA based on the length of the continuation time Td. This therefore enables execution of adequate deceleration control of the host vehicle CA even if the external vehicle CB, which is located relatively close to the host vehicle CA, is cutting in front of the host vehicle CA.

The ECU 10 is configured to change, based on the variation in the longitudinal distance D2 with respect to the continuation time Td, the target deceleration AD in the deceleration control of the host vehicle CA in a period during which the close-range determiner 11 continues the determination that the cut-in state of the external vehicle CB is the close-range cut-in state.

This configuration makes it possible to, in the close-range cut-in state of the external vehicle CB, adjust the deceleration of the host vehicle CA in accordance with (i) an approach cut-in situation (scene) in which the external vehicle CA is approaching the host vehicle CA or (ii) a separation cut-in situation (scene) in which the external vehicle CA is separating from the host vehicle CA. This therefore properly suppresses both cases where the deceleration becomes excessive and cases where the deceleration becomes insufficient in the deceleration control of the host vehicle CA.

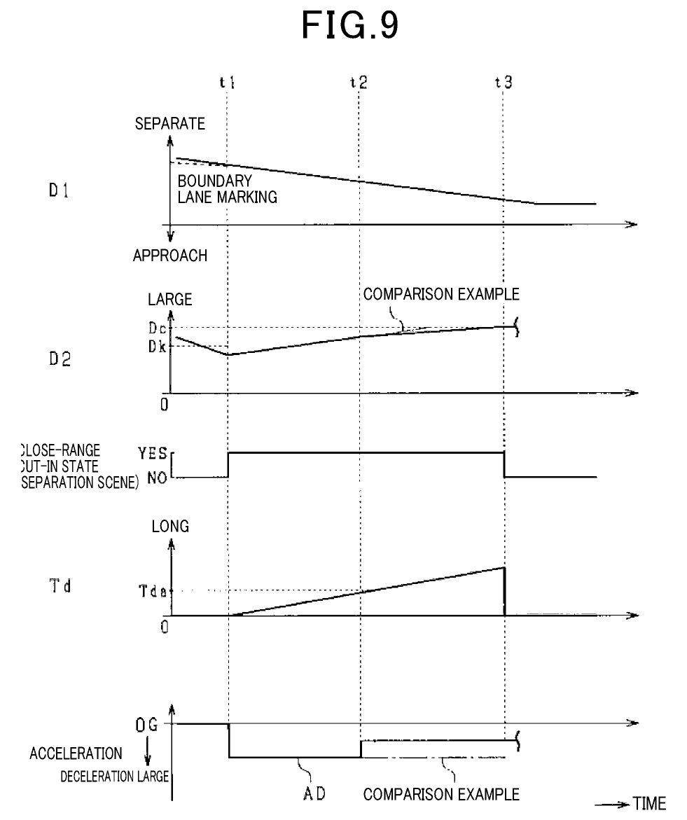

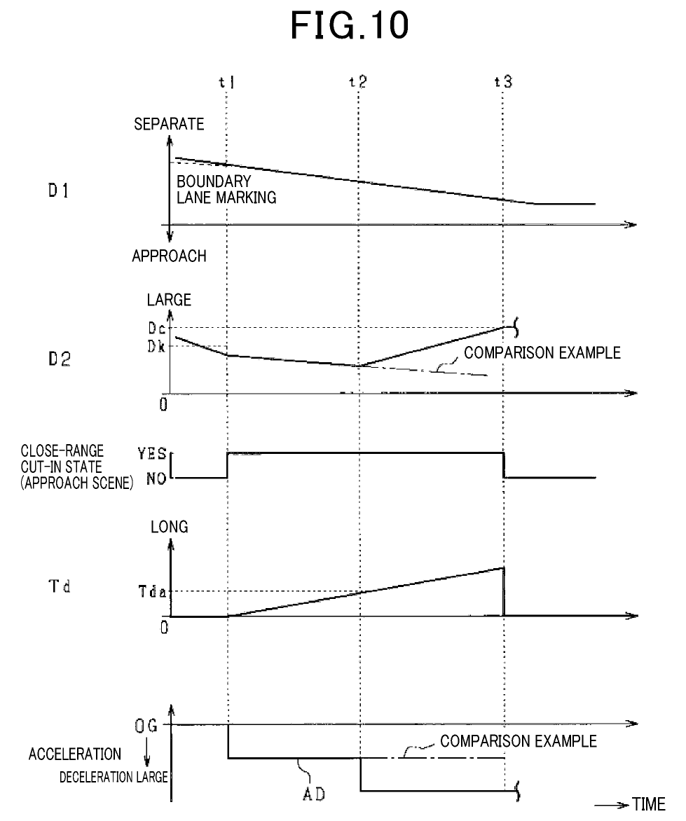

The following describes how the deceleration control of the host vehicle CA is performed according to the present embodiment with reference to the timing charts of FIGS. 9 and 10.

Specifically, FIG. 9 is the timing chart illustrating transition of (i) the lateral distance D1, (ii) the longitudinal distance D1, (iii) the close-range cut-in state, (iv) the continuation time Td, and (iii) the negative acceleration (deceleration) in the separation scene in which the external vehicle CB is separating from the host vehicle CA in the close-range cut-in state. FIG. 10 is the timing chart illustrating transition of (i) the lateral distance D1, (ii) the longitudinal distance D1, (iii) the close-range cut-in state, (iv) the continuation time Td, and (iii) the negative acceleration (deceleration) in the approach scene in which the external vehicle CB is approaching the host vehicle CA in the close-range cut-in state. In each of FIG. 9 and 10, the mark “YES” indicates that the cut-in state of the external vehicle CB is determined to be the close-range cut-in state, whereas the mark “NO” indicates that the cut-in state of the external vehicle CB is determined not to be the close-range cut-in state. Additionally, for illustrative purposes, each of FIGS. 9 and 10 illustrates the transition of each of the parameters when the target deceleration AD is adjusted stepwisely based on the longitudinal distance D2 and the continuation time Td.

First, the following describes how the deceleration control of the host vehicle CA is performed in an exemplary separation scene in which the external vehicle CB is separating from the host vehicle CA in the close-range cut-in state with reference to FIG. 9.

At time t1 in the timing chart of FIG. 9, the longitudinal distance D2 is smaller than the first close-range determination value Dk and a portion of the external vehicle CB closest to the host lane L1 has just reached the boundary lane marking between the lanes L1 and L2. In response to determination of this situation, the close-range determiner 11 determines that the cut-in state of the external vehicle CB is the close-range cut-in state. In response to determination that the cut-in state of the external vehicle CB is the close-range cut-in state, the deceleration determiner 12 starts counting the continuation time Td from 0, and sets the target deceleration AD, which is negative acceleration, of the host vehicle CA to the initial deceleration level. After the time t1, controlling the deceleration of the host vehicle CA to the initial deceleration level of the target deceleration AD results in the longitudinal distance D2 increasing.

Before the time t1, although the longitudinal distance D2 is smaller than the first close-range determination value Dk, the portion of the external vehicle CB closest to the host lane L1 is separated from the boundary lane marking between the lanes L1 and L2, in other words, the lateral distance D1 from the host vehicle CA to the external vehicle CB is greater than the predetermined cut-in determination value. For this reason, the close-range determiner 11 determines that the cut-in state of the external vehicle CB is not the close-range cut-in state.

At time t2, the continuation time Td reaches the predetermined count value Tda. For a predetermined period during which the continuation time Td increases to reach the predetermined count value Tda, the longitudinal distance D2 has increased. In this case, the deceleration controller 12 changes, at the time t2, the target deceleration AD from the initial deceleration level to a lower deceleration level. This results in the degree of increase in the longitudinal distance D2 after the time t2 being smaller than that during the period from the time t1 to the time t2. At time t3, the longitudinal distance D2 reaches the cancel determination value Dc. In response to the longitudinal distance D2 reaching the cancel determination value Dc in the close-range cut-in state, the close-range determiner 11 determines that the cut-in state of the external vehicle CB is not the close-range cut-in state, thus cancelling the close-range cut-in state.

FIG. 9 illustrates, using dash-dot lines, a comparative example where the target deceleration AD is not adjusted based on the continuation time Td during the period from the time t1 to the time t3 in which the cut-in state of the external vehicle CB is determined to be the close-range cut-in state.

Specifically, the present embodiment is configured to change the target deceleration AD of the host vehicle CA in the deceleration control to a lower deceleration level on condition that the continuation time Td reaches the predetermined count value Tda during a period in which the cut-in state of the external vehicle CB is determined to be the close-range cut-in state. This configuration therefore makes it possible to ensure a sufficient inter-vehicle distance between the host vehicle CA and the external vehicle CB while applying apply a smaller level of deceleration to the host vehicle CA as compared with the comparative example. Accordingly, the present embodiment prevents one or more occupants of the host vehicle CA from feeling uncomfortable and suppresses unnecessary deceleration in the deceleration control of the host vehicle CA.

More specifically, the present embodiment is configured to change the target deceleration AD of the host vehicle CA in the deceleration control to a lower deceleration level on condition that the longitudinal distance D2 increases before the continuation time Td reaches and exceeds the predetermined count value Tda in a period during which the cut-in state of the external vehicle CB is determined to be the close-range cut-in state. This configuration changes the target deceleration AD of the host vehicle CA in the deceleration control to a lower deceleration level based on the understanding that the host vehicle CA is separating from the external vehicle CB so that the host vehicle CA is likely not to collide with the external vehicle CB. This configuration therefore makes it possible to appropriately execute control of suppressing unnecessary deceleration in the deceleration control of the host vehicle CA.

Next, the following describes how the deceleration control of the host vehicle CA is performed in an exemplary approach scene in which the external vehicle CB is approaching the host vehicle CA in the close-range cut-in state with reference to FIG. 10.

The deceleration control illustrated in FIG. 10 before time t1 is substantially identical to that illustrated in FIG. 9

During the period from the time t1 to time t2, the external vehicle CB is approaching the host vehicle CA because deceleration of the host vehicle CA based on the initial deceleration level of the target deceleration AD is insufficient. This results in the longitudinal distance D2 decreasing.

At the time t2, the continuation time Td reaches the predetermined count value Tda. For a predetermined period during which the continuation time Td increases to reach the predetermined count value Tda, the longitudinal distance D2 has decreased. In this case, the deceleration controller 12 changes, at the time t2, the target deceleration AD from the initial deceleration level to a greater deceleration level. This results in the degree of increase in the longitudinal distance D2 after the time t2 being greater than that during the period from the time t1 to the time t2. At time t3, the longitudinal distance D2 reaches the cancel determination value Dc. In response to the longitudinal distance D2 reaching the cancel determination value Dc in the close-range cut-in state, the close-range determiner 11 determines that the cut-in state of the external vehicle CB is not the close-range cut-in state, thus cancelling the close-range cut-in state.

FIG. 10 illustrates, using dash-dot lines, a comparative example where the target deceleration AD is not adjusted based on the continuation time Td during the period from the time t1 to the time t3 in which the cut-in state of the external vehicle CB is determined to be the close-range cut-in state. In the comparison example, because adjustment of the target deceleration AD is not performed although the deceleration of the host vehicle CA is insufficient, the external vehicle CB is likely to continuously approach the host vehicle CA during execution of the deceleration control of the host vehicle CA. This may increase a possibility that the host vehicle CA will collide with the external vehicle CB due to the close-range cut-in state persisting. Additionally, when the tracking control, such as the ACC, which uses the external vehicle CB as its target preceding vehicle, is started after cut-in of the external vehicle CB in front of the host vehicle CA is completed in the close-range cut-in state, an excessively large level of deceleration may be applied to the host vehicle CA.

In contrast, the present embodiment is configured to change the target deceleration AD of the host vehicle CA in the deceleration control to a greater deceleration level on condition that the continuation time Td reaches the predetermined count value Tda during a period in which the cut-in state of the external vehicle CB is determined to be the close-range cut-in state. This configuration prevents the close-range cut-in state of the external vehicle CB from being excessively longer, making it possible to properly reduce a possibility that the host vehicle CA will collide with the external vehicle CB in the close-range cut-in state of the external vehicle CB. Additionally, the present embodiment cancels the close-range cut-in state of the external vehicle CB as much as possible before the tracking control, which uses the external vehicle CB as its target preceding vehicle, is started, making it possible to prevent an excessively large level of deceleration from being applied to the host vehicle CA at the start of the tracking control.

More specifically, the present embodiment is configured to change the target deceleration AD of the host vehicle CA in the deceleration control to a greater deceleration level on condition that the longitudinal distance D2 decreases before the continuation time Td reaches and exceeds the predetermined count value Tda in a period during which the cut-in state of the external vehicle CB is determined to be the close-range cut-in state. This configuration changes the target deceleration AD of the host vehicle CA in the deceleration control to a greater deceleration level based on the understanding that the host vehicle CA is approaching the external vehicle CB so that the host vehicle CA is likely to collide with the external vehicle CB. This configuration therefore makes it possible to appropriately execute control of preventing the host vehicle CA from colliding with the external vehicle CB in the deceleration control of the host vehicle CA.

The target deceleration AD according to the present disclosure, an example of which is adjusted stepwisely in the close-range cut-in state of the external vehicle CB as illustrated in each of FIGS. 9 and 10, is not limited thereto. Specifically, the target deceleration AD according to the present disclosure may be adjusted in a selected one of the following scenarios.

In the first scenario, the target deceleration AD may be adjusted each time the continuation time Td reaches one of predetermined count values; each of the count values is defined as a timing to adjust the target deceleration AD. In this modification, the deceleration determiner 12 may be configured to adjust, in the close-range cut-in state of the external vehicle CB, the target deceleration AD in multiple stages in accordance with the current value of the longitudinal distance D2, the current value of the continuation time Td, and the map information illustrated in each of FIGS. 5 and 6.

In the second scenario, the target deceleration AD may be adjusted each time the continuation time Td is incremented. In this modification, the deceleration determiner 12 may be configured to continuously adjust, in the close-range cut-in state of the external vehicle CB, the target deceleration AD in accordance with the current value of the longitudinal distance D2, the incremented value of the continuation time Td, and the map information illustrated in each of FIGS. 5 and 6.

### Modifications

The present embodiment may be modified as follows:

The map information in which the longitudinal distance D2, the continuation time Td, and the target deceleration AD are associated with each other is not limited to that illustrated in each of FIGS. 5 and 6. For example, when the external vehicle CB cuts in, if the close-range cut-in state unintentionally continues for a long time, the state in which the detection accuracy of the external vehicle CB is low also continues for a long time, which is undesirable.

From this viewpoint, the tendency of the map information may be defined such that the longer the continuation time Td, the larger the target deceleration AD is set. In this modification, the deceleration control unit 12 may set the target deceleration AD to a greater level as the continuation time Td becomes longer, even when the relational expression Da < D2 < Dc is satisfied and the longitudinal distance D2 remains unchanged or increases during counting of the continuation time Td.

When the longitudinal distance D2 satisfies the following relationship defined by the relational expression 0 ≤ D2 ≤ Da, the target deceleration AD is set to the maximum deceleration level in the deceleration control, but the present disclosure is not limited thereto. Specifically, the target deceleration AD may be set to a predetermined deceleration level that is greater than the deceleration level set when the relational expression Da < D2 < Dc is satisfied and smaller than the maximum deceleration level.

The deceleration control unit 12 may variably set the initial deceleration level of the target deceleration AD based on the longitudinal distance D2, instead of setting it to a fixed deceleration level.

Specifically, when the longitudinal distance D2 satisfies the following relationship defined by the relational expression 0 ≤ D2 ≤ Da, the deceleration control unit 12 may set the initial deceleration level of the target deceleration AD to the maximum deceleration level that can be set in the deceleration control.

When the longitudinal distance D2 satisfies the following relationship defined by the relational expression Da < D2 < Dc, the deceleration control unit 12 may set the initial deceleration level of the target deceleration AD to a smaller deceleration level as the longitudinal distance D2 increases. For example, if the maximum deceleration level of the target deceleration AD in the deceleration control is −0.1G, the initial deceleration level of the target deceleration AD when the longitudinal distance D2 satisfies the following relationship defined by the relational expression Da < D2 < Dc may be set within a range of −0.1G < AD < 0G.

In FIG. 8, the processor 100 may be configured not to execute the operation in step S11. In this modification, the longitudinal distance D2, which has not been subjected to the smoothing process, may be used in the operation in each of steps S17 and S18.

In FIG. 8, the processor 100 may be configured not to execute the operation in step S17. In this modification, the processor 100 may be configured to control the accelerator device 31 and/or the brake device 32 to adjust the braking force of the host vehicle CA, thus causing the deceleration of the host vehicle CA to become the target deceleration AD regardless of the jerk of the host vehicle CA in step S19.

The above present embodiment has described a configuration in which whether the external vehicle CB cuts in ahead of the host vehicle CA is determined based on the lateral distance D1 from the host vehicle CA to the external vehicle CB. However, this configuration may be modified. For example, instead of the lateral distance D1, whether the external vehicle CB cuts in ahead of the host vehicle CA may be determined based on a lateral velocity of the external vehicle CB.

The above present embodiment has described a configuration in which one radar device 22 is mounted to the middle position of the front end of the host vehicle CA (see FIG. 2). However, this configuration may be modified such that radar devices 22 are mounted at the respective left and right front corner portions of the host vehicle CA.

The ECU 10 and the methods carried out thereby described in the present disclosure may be implemented by a dedicated computer provided so as to include a processor, which has been programmed to execute one or a plurality of functions (commands) embodied by a computer program, and a memory.

Alternatively, the ECU 10 and the methods carried out thereby described in the present disclosure may be implemented by a dedicated computer provided so as to include a processor formed of one or more dedicated hardware logic circuits. Alternatively, the ECU 10 and the methods carried out thereby described in the present disclosure may be implemented by one or more dedicated computers configured to include a combination of a processor, which has been programmed to execute one or a plurality of functions, and a memory, with a processor formed of one or more hardware logic circuits. The computer program may be, as an instruction to be executed by a computer, stored in a computer-readable non-transitory tangible memory medium.

Modifications of the present disclosure are not limited to those described set forth above. For example, specific examples described set forth above can be combined with each other unless the combination produces technological inconsistency, and similarly the modifications set forth above can be combined with each other unless the combination produces technological inconsistency. At least part of the exemplary embodiment can be combined with at least part of the modifications set forth above unless the combination produces technological inconsistency.

As clearly seen by the descriptions of the present embodiment and its modifications, the present disclosure includes the following technological concepts.

### Technological Concept 1

The technological concept 1 provides a vehicle control apparatus applicable to a host vehicle traveling in a host lane and including a detection device for detecting an object located around the host vehicle. The vehicle control apparatus includes an acquiring unit configured to acquire, from the detection device, detection information related to an external vehicle traveling in an adjacent lane that is adjacent to a host lane of the host vehicle and has a same traffic direction as the host lane, and a close-range determiner configured to determine, upon the external vehicle cutting in front of the host vehicle, whether a cut-in state of the external vehicle is a close-range cut-in state in accordance with the detection information related to the external vehicle. The close-range cut-in state is defined as a state in which an inter-vehicle distance between the host vehicle and the external vehicle is smaller than at least one close-range determination value. The vehicle control apparatus include a deceleration controller configured to control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

### Technological Concept 2

In the vehicle control apparatus of the technological concept 2, which depends from the technological concept 1, the deceleration controller is configured to change, based on a variation in the inter-vehicle distance with respect to the continuation time, the deceleration of the host vehicle in a period during which the close-range determiner continuously determines that the cut-in state of the external vehicle is the close-range cut-in state.

### Technological Concept 3

In the vehicle control apparatus of the technological concept 3, which depends from the technological concept 1 or 2, the deceleration controller is configured to change a level of the deceleration of the host vehicle to a lower level in response to determination that the continuation time exceeds a predetermined time in a period during which the close-range determiner continuously determines that the cut-in state of the external vehicle is the close-range cut-in state in a separate situation in which the inter-vehicle distance increases as the continuation time increases.

### Technological Concept 4

In the vehicle control apparatus of the technological concept 4, which depends from the technological concept 1 or 2, the deceleration controller is configured to change a level of the deceleration of the host vehicle to a lower level in response to determination that (i) the continuation time exceeds a predetermined time in a period during which the close-range determiner continuously determines that the cut-in state of the external vehicle is the close-range cut-in state, and (ii) the inter-vehicle distance increases before the continuation time exceeds the predetermined time in the period.

### Technological Concept 5

In the vehicle control apparatus of the technological concept 5, which depends from any one of the technological concepts 1 to 4, the deceleration controller is configured to change a level of the deceleration of the host vehicle to a greater level in response to determination that the continuation time exceeds a predetermined time in a period during which the close-range determiner continuously determines that the cut-in state of the external vehicle is the close-range cut-in state in an approach situation in which the inter-vehicle distance decreases as the continuation time increases.

### Technological Concept 6

In the vehicle control apparatus of the technological concept 6, which depends from any one of the technological concepts 1 to 5, the deceleration controller is configured to change a level of the deceleration of the host vehicle to a greater level in response to determination that (i) the continuation time exceeds a predetermined time in a period during which the close-range determiner continuously determines that the cut-in state of the external vehicle is the close-range cut-in state, and (ii) the inter-vehicle distance decreases before the continuation time exceeds the predetermined time in the period.

### Technological Concept 7

In the vehicle control apparatus of the technological concept 7, which depends from any one of the technological concepts 1 to 6, the at least one close-range determination value includes a first close-range determination value and a second close-range determination value, and the close-range cut-in state is defined as the state in which the inter-vehicle distance between the host vehicle and the external vehicle is smaller than the first close-range determination value. The deceleration controller is configured to adjust, in response to determination that the cut-in state of the external vehicle is the close-range cut-in state, a level of the deceleration of the host vehicle to a predetermined first deceleration level independently of the continuation time in response to determination that the inter-vehicle distance is smaller than the second close-range determination value. The deceleration controller is configured to adjust, in response to determination that the cut-in state of the external vehicle is the close-range cut-in state, the level of the deceleration of the host vehicle to a predetermined second deceleration level in response to determination that the inter-vehicle distance is greater than or equal to the second close-range determination value, the predetermined first deceleration level being set to be greater than the second deceleration level.

### Technological Concept 8

The vehicle control apparatus of the technological concept 8, which depends from any one of the technological concepts 1 to 7, further includes a limit setter configured to set a limit value that limits a rate of change of the deceleration of the host vehicle. The deceleration controller is configured to control the deceleration of the host vehicle to cause the rate of change of the deceleration of the host vehicle to be smaller than or equal to the limit value.

### Technological Concept 9

In the vehicle control apparatus of the technological concept 9, which depends from the technological concept 8, the limit setter is configured to set the limit value to a smaller value in response to determination that the inter-vehicle distance is greater than a predetermined threshold distance.

### Technological Concept 10

The vehicle control apparatus of the technological concept 10, which depends from any one of the technological concepts 1 to 9, further includes a smoothing processing unit configured to perform a smoothing process of suppressing fluctuations in the detection information.

### Technological Concept 11

The technological concept 11 provides a program product for controlling a host vehicle traveling in a host lane and including a detection device for detecting an object located around the host vehicle. The program product includes a non-transitory storage medium, and computer-program instructions stored in the non-transitory storage medium. The computer-program instructions cause a processor to

(I) Acquire, from the detection device, detection information related to an external vehicle traveling in an adjacent lane that is adjacent to a host lane of the host vehicle and has a same traffic direction as the host lane,

(II) Determine, upon the external vehicle cutting in front of the host vehicle, whether a cut-in state of the external vehicle is a close-range cut-in state in accordance with the detection information related to the external vehicle, the close-range cut-in state being defined as a state in which an inter-vehicle distance between the host vehicle and the external vehicle is smaller than at least one close-range determination value, and

(III) Control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

### Technological Concept 12

The technological concept 12 provides a vehicle control method for a host vehicle traveling in a host lane and including a detection device for detecting an object located around the host vehicle. The vehicle control method includes

(I) Acquiring, from the detection device, detection information related to an external vehicle traveling in an adjacent lane that is adjacent to a host lane of the host vehicle and has a same traffic direction as the host lane,

(II) Determining, upon the external vehicle cutting in front of the host vehicle, whether a cut-in state of the external vehicle is a close-range cut-in state in accordance with the detection information related to the external vehicle, the close-range cut-in state being defined as a state in which an inter-vehicle distance between the host vehicle and the external vehicle is smaller than at least one close-range determination value, and

(III) Controlling, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

1. A vehicle control apparatus applicable to a host vehicle traveling in a host lane and including a detection device for detecting an object located around the host vehicle, the vehicle control apparatus comprising:
an acquiring unit configured to acquire, from the detection device, detection information related to an external vehicle traveling in an adjacent lane that is adjacent to the host lane and has a same traffic direction as the host lane;
a close-range determiner configured to determine, upon the external vehicle cutting in front of the host vehicle, whether a cut-in state of the external vehicle is a close-range cut-in state in accordance with the detection information related to the external vehicle, the close-range cut-in state being defined as a state in which an inter-vehicle distance between the host vehicle and the external vehicle is smaller than at least one close-range determination value; and
a deceleration controller configured to control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

2. The vehicle control apparatus according to claim 1, wherein:
the deceleration controller is configured to change, based on a variation in the inter-vehicle distance with respect to the continuation time, the deceleration of the host vehicle in a period during which the close-range determiner continuously determines that the cut-in state of the external vehicle is the close-range cut-in state.

3. The vehicle control apparatus according to claim 1, wherein:
the deceleration controller is configured to change a level of the deceleration of the host vehicle to a lower level in response to determination that the continuation time exceeds a predetermined time in a period during which the close-range determiner continuously determines that the cut-in state of the external vehicle is the close-range cut-in state in a separate situation in which the inter-vehicle distance increases as the continuation time increases.

4. The vehicle control apparatus according to claim 1, wherein:
the deceleration controller is configured to change a level of the deceleration of the host vehicle to a lower level in response to determination that:
the continuation time exceeds a predetermined time in a period during which the close-range determiner continuously determines that the cut-in state of the external vehicle is the close-range cut-in state; and
the inter-vehicle distance increases before the continuation time exceeds the predetermined time in the period.

5. The vehicle control apparatus according to claim 1, wherein:
the deceleration controller is configured to change a level of the deceleration of the host vehicle to a greater level in response to determination that the continuation time exceeds a predetermined time in a period during which the close-range determiner continuously determines that the cut-in state of the external vehicle is the close-range cut-in state in an approach situation in which the inter-vehicle distance decreases as the continuation time increases.

6. The vehicle control apparatus according to claim 1, wherein:
the deceleration controller is configured to change a level of the deceleration of the host vehicle to a greater level in response to determination that:
the continuation time exceeds a predetermined time in a period during which the close-range determiner continuously determines that the cut-in state of the external vehicle is the close-range cut-in state; and
the inter-vehicle distance decreases before the continuation time exceeds the predetermined time in the period.

7. The vehicle control apparatus according to claim 1, wherein:
the at least one close-range determination value includes a first close-range determination value and a second close-range determination value;
the close-range cut-in state is defined as the state in which the inter-vehicle distance between the host vehicle and the external vehicle is smaller than the first close-range determination value; and
the deceleration controller is configured to:
adjust, in response to determination that the cut-in state of the external vehicle is the close-range cut-in state, a level of the deceleration of the host vehicle to a predetermined first deceleration level independently of the continuation time in response to determination that the inter-vehicle distance is smaller than the second close-range determination value; and
adjust, in response to determination that the cut-in state of the external vehicle is the close-range cut-in state, the level of the deceleration of the host vehicle to a predetermined second deceleration level in response to determination that the inter-vehicle distance is greater than or equal to the second close-range determination value, the predetermined first deceleration level being set to be greater than the second deceleration level.

8. The vehicle control apparatus according to claim 1, further comprising:
a limit setter configured to set a limit value that limits a rate of change of the deceleration of the host vehicle, wherein:
the deceleration controller is configured to control the deceleration of the host vehicle to cause the rate of change of the deceleration of the host vehicle to be smaller than or equal to the limit value.

9. The vehicle control apparatus according to claim 8, wherein:
the limit setter is configured to set the limit value to a smaller value in response to determination that the inter-vehicle distance is greater than a predetermined threshold distance.

10. The vehicle control apparatus according to claim 1, further comprising:
a smoothing processing unit configured to perform a smoothing process of suppressing fluctuations in the detection information.

11. A program product for controlling a host vehicle traveling in a host lane and including a detection device for detecting an object located around the host vehicle, the program product comprising:
a non-transitory storage medium; and
computer-program instructions stored in the non-transitory storage medium,
the computer-program instructions causing a processor to:
acquire, from the detection device, detection information related to an external vehicle traveling in an adjacent lane that is adjacent to the host lane and has a same traffic direction as the host lane;
determine, upon the external vehicle cutting in front of the host vehicle, whether a cut-in state of the external vehicle is a close-range cut-in state in accordance with the detection information related to the external vehicle, the close-range cut-in state being defined as a state in which an inter-vehicle distance between the host vehicle and the external vehicle is smaller than at least one close-range determination value; and
control, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.

12. A vehicle control method for a host vehicle traveling in a host lane and including a detection device for detecting an object located around the host vehicle, the vehicle control method comprising:
acquiring, from the detection device, detection information related to an external vehicle traveling in an adjacent lane that is adjacent to the host lane and has a same traffic direction as the host lane;
determining, upon the external vehicle cutting in front of the host vehicle, whether a cut-in state of the external vehicle is a close-range cut-in state in accordance with the detection information related to the external vehicle, the close-range cut-in state being defined as a state in which an inter-vehicle distance between the host vehicle and the external vehicle is smaller than at least one close-range determination value; and
controlling, in response to determination that the cut-in state of the external vehicle is the close-range cut-in state, deceleration of the host vehicle based on (i) the detection information related to the external vehicle and (ii) a continuation time during which the close-range determiner continuously determines that the cut-in state of the external vehicle is the close-range cut-in state.
